(19) United States
(12) Patent Application Publication
(10) Pub. No.: US 2014/0138358 A1
(43) Pub. Date: May 22, 2014

(54) COMPONENT REPAIR ARRANGEMENT AND METHOD

(71) Applicant: GENERAL ELECTRIC COMPANY, Schenectady, NY (US)

(72) Inventors: Dechao Lin, Greer, SC (US); David Vincent Bucci, Simpsonville, SC (US); Srikanth Chandrudu Kottilingam, Simpsonville, SC (US)

(73) Assignee: GENERAL ELECTRIC COMPANY, Schenectady, NY (US)

(21) Appl. No.: 13/683,125

(22) Filed: Nov. 21, 2012

(51) Int. Cl. B23K 9/16

(52) U.S. Cl. CPC B23K 9/16
USPC 219/74

(57) ABSTRACT

A component repair arrangement includes a material depositing electrospark rod configured to deposit a material onto the component. Also included is a first routing hose for flowing a first shielding gas to a location proximate a tip of the material depositing electrospark rod, the first shielding gas removing a plurality of sparks generated proximate the tip.

### BACKGROUND OF THE INVENTION

The subject matter disclosed herein relates to turbine systems, and more particularly to a component repair arrangement, as well as a method of repairing a component.

Turbine systems include a large number of components that are subjected to stressful conditions during normal operation of the turbine system. The large mechanical forces exerted on the components, combined with high temperature operating conditions, often results in damage to the components. Such damage may include wearing, corrosion, creep and oxidation, for example, and typically leads to scrapping of the components. Replacement of the scrapped components is costly and undesirable to operators of the turbine system.

Repair efforts have been attempted to avoid or mitigate replacement costs associated with scrapping of the turbine system components. Efforts have included depositing material on the damaged turbine system component and subsequently machining the deposited material to desired dimensions. Such a process may include multiple cumbersome and time-consuming iterations and the newly applied coating is typically not durable and requires similar repair efforts after a relatively brief time subsequent to re-entering the operating cycle of the turbine system. Additionally, the repaired component is often left with undesirable oxides, thereby weakening the structural integrity of the component.

### BRIEF DESCRIPTION OF THE INVENTION

According to one aspect of the invention, a component repair arrangement includes a material depositing electrospark rod configured to deposit a material onto the component. Also included is a first routing hose for flowing a first shielding gas to a location proximate a tip of the material depositing electrospark rod, the first shielding gas removing a plurality of sparks generated proximate the tip.

According to another aspect of the invention, a method of repairing a component is provided. The method includes depositing a material by electrospark deposition to a damaged surface of the component. Also included is flowing a first shielding gas proximate the damaged surface during deposition of the material for removing a plurality of sparks from the damaged surface.

According to yet another aspect of the invention, a method of repairing a turbine system component is provided. The method includes depositing a material by electrospark deposition in a plurality of passes to a damaged surface of the turbine system component. Also included is flowing a shielding gas at a first velocity proximate the damaged surface during at least one of the plurality of passes for removing a plurality of sparks from the damaged surface. Further included is flowing the shielding gas at a second velocity proximate the damaged surface during at least one of the plurality of passes, wherein the first velocity is greater than the second velocity.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features and advantages of the invention are apparent from the following detailed description taken in conjunction with the accompanying drawings in which:

FIG. 1 is a schematic illustration of a turbine system;

FIG. 2 is a partial, schematic side view of the turbine system;

FIG. 3 is a schematic illustration of an electrospark deposition system according to a first embodiment;

FIG. 4 is a schematic illustration of an electrospark deposition system according to a second embodiment; and

FIG. 5 is a flow diagram illustrating a method of repairing the turbine system component.

The detailed description explains embodiments of the invention, together with advantages and features, by way of example with reference to the drawings.

### DETAILED DESCRIPTION OF THE INVENTION

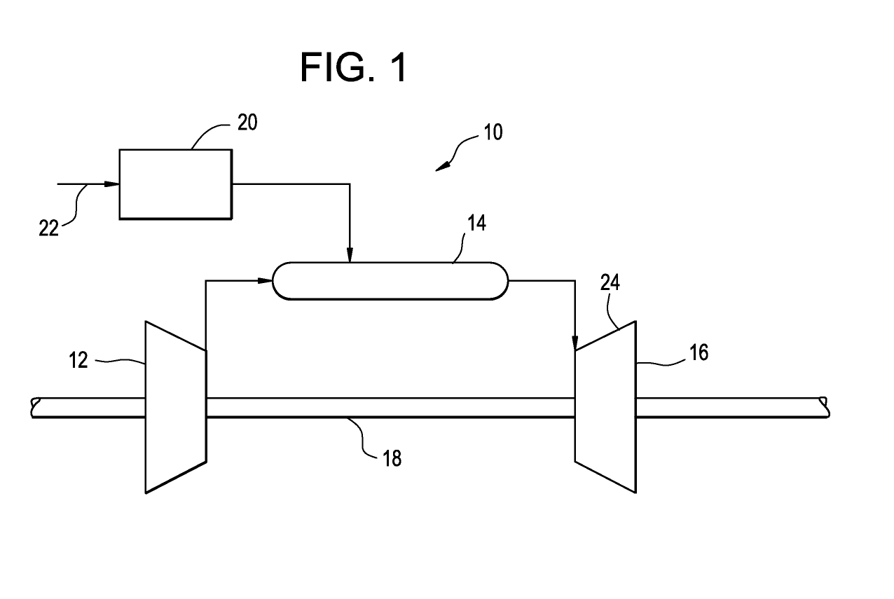

Referring to FIG. 1, a turbine system, such as a gas turbine system, is schematically illustrated with reference numeral 10. The gas turbine system 10 includes a compressor 12, a combustor 14, a turbine 16, a rotor 18 and a fuel nozzle 20. It is to be appreciated that one embodiment of the gas turbine system 10 may include a plurality of compressors 12, combustors 14, turbines 16, rotors 18 and fuel nozzles 20. The compressor 12 and the turbine 16 are coupled by the rotor 18. The rotor 18 may be a single rotor or a plurality of rotor segments coupled together to form the rotor 18.

The combustor 14 uses a combustible liquid and/or gas fuel, such as natural gas or a hydrogen rich synthetic gas, to run the gas turbine system 10. For example, fuel nozzles 20 are in fluid communication with an air supply and a fuel supply 22. The fuel nozzles 20 create an air-fuel mixture, and discharge the air-fuel mixture into the combustor 14, thereby causing a combustion that creates a hot pressurized exhaust gas. The combustor 14 directs the hot pressurized gas through a transition piece into a turbine nozzle (or “stage one nozzle”), and other stages of buckets and nozzles causing rotation of the turbine 16 within a turbine casing 24. Rotation of the turbine 16 causes the rotor 18 to rotate, thereby compressing the air as it flows into the compressor 12.

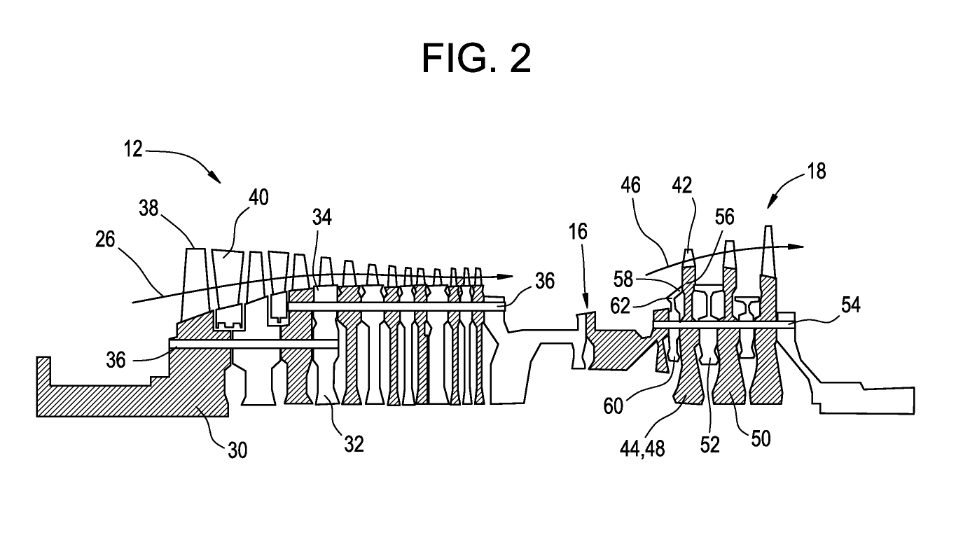

Referring to FIG. 2, a partial schematic illustrates in greater detail the compressor 12 and the turbine 16, which are operably coupled by the rotor 18. In the compressor 12, a plurality of stacked wheels includes a plurality of solid wheels 30 and a plurality of annular wheels 32, with the plurality of solid wheels 30 arranged alternately between the plurality of annular wheels 32. Both the plurality of solid wheels 30 and the plurality of annular wheels 32 are mounted on, and form, a portion of the rotor 18, with the plurality of annular wheels 32 and the plurality of solid wheels 30 operably coupled by one or more axial compressor bolts 36. The rotor 18 includes a rim portion 34 disposed at a radially outward position of the rotor 18. Each of the plurality of solid wheels 30 and the plurality of annular wheels 32 includes a rotor blade 38 projecting radially outwardly from the rotor 18, while a plurality of stator vanes 40 is mounted on a stator (not illustrated). Each of the plurality of stator vanes 40 is typically positioned alternately between the rotor blades 38 and for illustration simplicity, only two of the plurality of stator vanes 40 are referenced. The rotor blades 38 and the plurality of stator vanes 40 form a passage through which the main flow path 26 in the compressor 12 flows.

In the turbine 16, a plurality of stages each include airfoils comprising a plurality of buckets 42 circumferentially spaced and mounted on a turbine wheel 44, as well as a plurality of circumferentially spaced nozzles (not illustrated) mounted on stationary components. Both the plurality of buckets 42 and the plurality of circumferentially spaced nozzles are disposed in a hot gas path 46. As described above, each of the plurality of buckets 42 are mounted on the turbine wheel 44, such as a first turbine wheel 48 and a second turbine wheel 50. The first turbine wheel 48 and the second turbine wheel 50 are joined together by a turbine spacer 52 to form a portion of the rotor 18, which rotates with respect to the turbine casing 24, with the first turbine wheel 48, the turbine spacer 52 and the second turbine wheel 50, as well as other wheels and spacers, are operably coupled by one or more axial turbine bolts 54.

At various interfaces between turbine system components, a rabbet structure 56 is positioned to achieve desired dimensional and positional control of the turbine system components at the various interfaces, as well as to provide a preload on the turbine system components. In one embodiment, the rabbet structure 56 is disposed in the compressor 12, while in another embodiment the rabbet structure 56 is disposed in the turbine 16. For example, the rabbet structure 56 may be located at an interface 58 between the first turbine wheel 48 and a forwardly disposed spacer 60. More specifically, the rabbet structure 56 is disposed proximate a spacer arm 62 and the first turbine wheel 48, thereby maintaining a tight securement during all operating conditions of the gas turbine system 10.

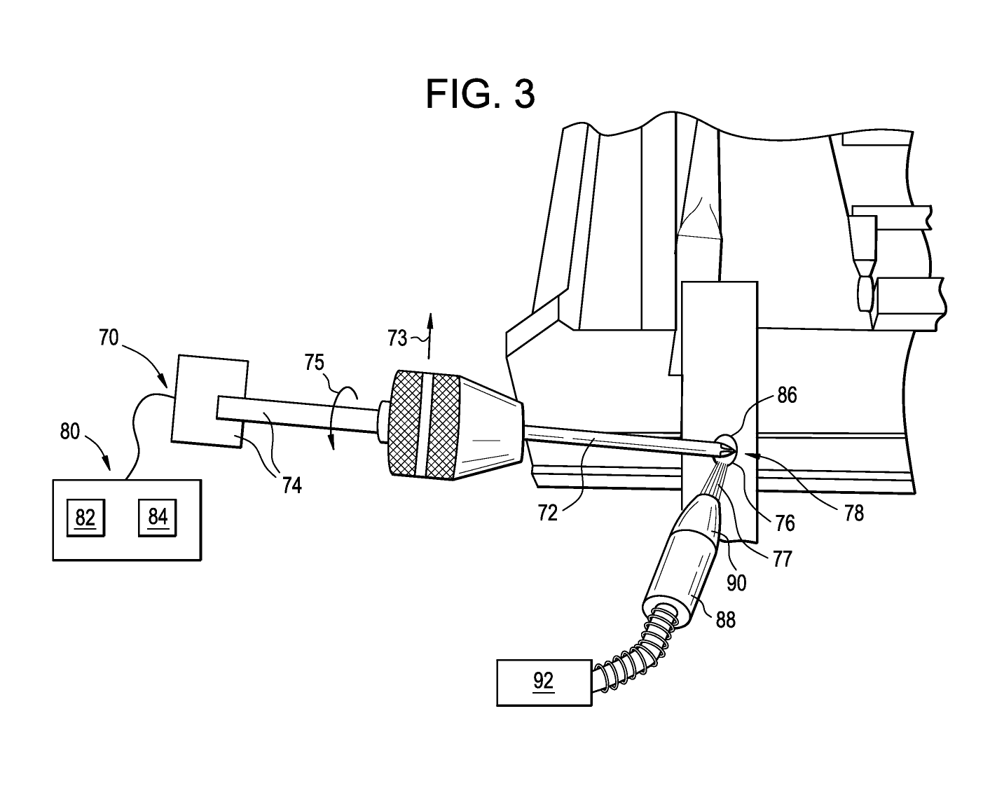

Referring now to FIG. 3, it is to be appreciated that during operation of the gas turbine system 10, various turbine system components are worn or damaged over time. Rather than scrapping the turbine system components, embodiments herein repair the damaged components. In the illustrated example, an electrospark deposition machine 70 includes a rotary rod 72 (rotational motion illustrated with reference numeral 75) operably coupled to a handle 74, where the electrospark deposition machine 70 is configured to deposit a material onto a damaged surface 76 of a turbine system component 78. It is to be appreciated that the turbine system component 78 may comprise numerous components. Examples of the turbine system component 78 in the compressor 12 include components such as the plurality of solid wheels 30 and the plurality of annular wheels 32, the rotor blade 38 and the plurality of stator vanes 40. Examples of the turbine system component 78 in the turbine 16 include components such as the plurality of buckets 42, the turbine wheel 44, the plurality of circumferentially spaced nozzles, any of the turbine wheels, such as the first turbine wheel 48 and the second turbine wheel 50 and the turbine spacer 52. Additionally, the rabbet structure 56, whether disposed at an interface in the compressor 12 or the turbine 16, may be the turbine system component 78 requiring repair. Irrespective of the turbine system component 78, it is to be appreciated that the preceding list is merely illustrative and is not intended to be limiting, as it is contemplated that numerous alternative components may benefit from the repair methods described herein.

The electrospark deposition machine 70 generates sparks via a spark generating assembly 80 that includes a voltage source 82 and, in one embodiment, a processor 84. The processor regulates the voltage applied from the voltage source 82 to deliver a pulsating current at a desired current level and frequency for the specific application. The material deposited on the damaged surface 76 comprises the material of the rotary rod 72. In one embodiment the rotary rod 72, and therefore the material deposited, comprises the same material as that of the material of the damaged surface 76. In another embodiment, the rotary rod 72, and therefore the material deposited, comprises a first material, while the damaged surface 76 comprises a second material.

In operation, electric sparks 86 are generated between the rotary rod 72 and the damaged surface 76 and pulsed, thereby delivering material from the rotary rod 72 to the damaged surface 76 to provide deposited material to the damaged surface. The material is deposited in a plurality of passes over the damaged surface 76, with each pass forming a metallurgical, fusion bond of the material and the damaged surface 76. Each of the plurality of passes forms a thin layer on the damaged surface 76 to repair the damaged area. During at least one of the plurality of passes of the rotary rod 72 over the damaged surface 76, a shielding gas 77 is flowed proximate the damaged surface 76 to disperse the sparks. This may be done during only a first pass or during numerous passes to establish a “clean” surface. Reference to a clean surface includes reducing the likelihood that oxides or other imperfections may form within the added layers on the damaged surface 76. The shielding gas 77 may comprise numerous gases and in one embodiment the shielding gas 77 comprises argon. The shielding gas 77 is sourced from a gas tank 92 and routed through a routing hose 88 and exits an outlet 90 at a desired location. The shielding gas 77 may be flowed at different velocities during different stages of the repair process, including during different plurality of passes of the rotary rod 72. In one embodiment, the shielding gas 77 is flowed at a first velocity during a first pass of the rotary rod 72 and at a second, lower velocity during the second pass of the rotary rod 72. It is to be appreciated that the second, lower velocity may include no shielding gas flow, corresponding to zero velocity. In one embodiment (FIG. 3), the shielding gas 77 is flowed at a first velocity and only flowed to the area between the tip of the rotary rod 72 and the damaged surface 76, such that the sparks can be removed by this strong flowing gas. As the rotary rod 72 is passed along a first direction 73, the shielding gas 77 is illustrated as flowing in a different direction.

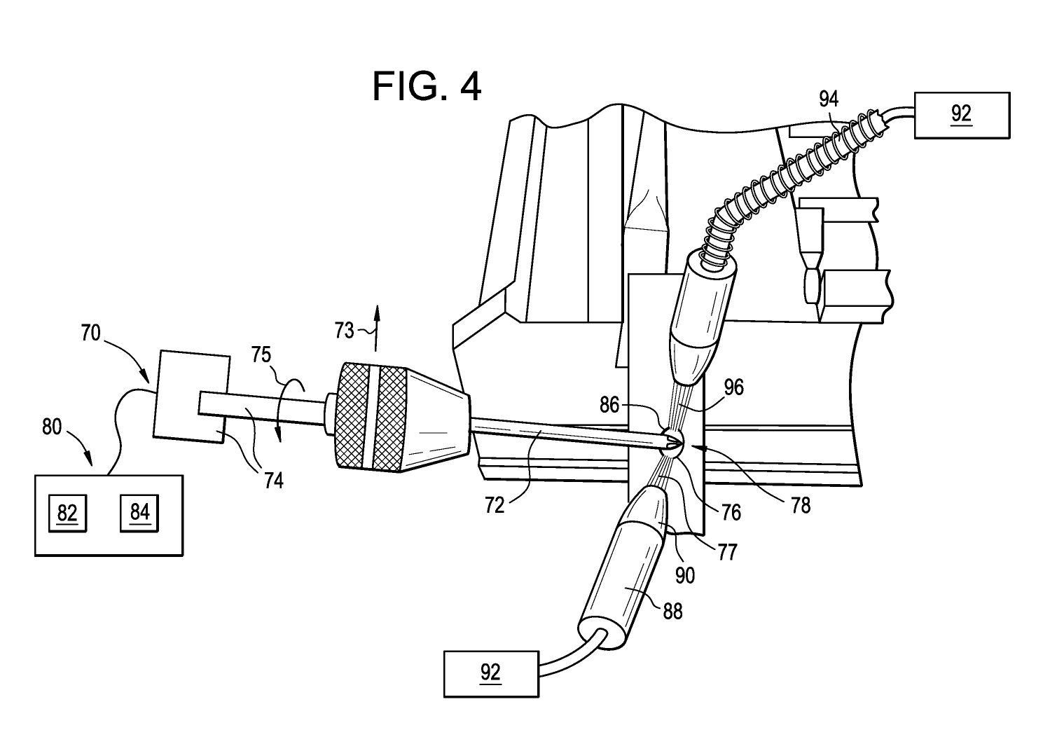

Referring to FIG. 4, the electrospark deposition machine 70 is illustrated according to a second embodiment. The second embodiment is similar in many respects to the first embodiment described in detail above, such that duplicative description is not necessary and similar reference numerals are employed. In the second embodiment, a second routing hose 94 is included in addition to the routing hose 88 described in conjunction with the first embodiment. While the routing hose 88 flows the shielding gas 77 to a location proximate a tip 94 of the rotary rod 72 and the damaged surface 76 to remove the electric sparks 86, the second routing hose 94 flows a second shielding gas 96 across the damaged surface 76 to reduce oxidation along the damaged surface 76.

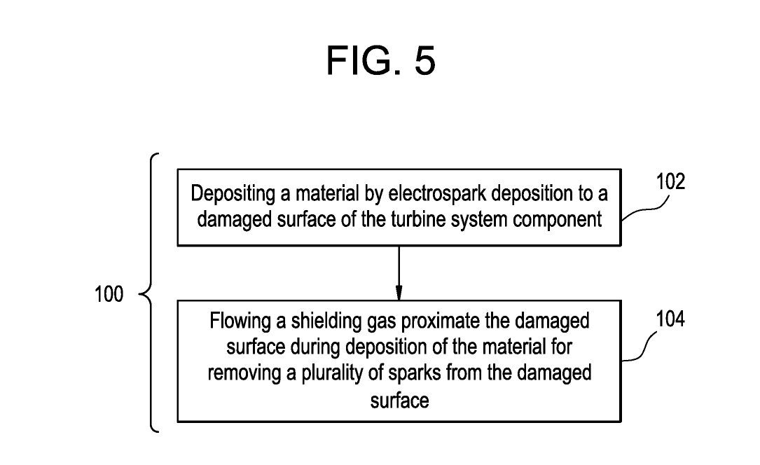

As illustrated in the flow diagram of FIG. 5, and with reference to FIGS. 1-4, a method of repairing a turbine system component 100 is also provided. The gas turbine system 10, and more specifically the compressor 12, rotor 18 and associated components have been previously described and specific structural components need not be described in further detail. The method of repairing a turbine system component 100 includes depositing a material by electrospark deposition to a damaged surface of the turbine system component 102. A shielding gas is flowed proximate the damaged surface during deposition of the material for removing a plurality of sparks from the damaged surface 104. Such a process advantageously cleans the damaged surfaces prior to application of following passes of coating material for the upcoming metal build up.

Advantageously, the method of repairing a turbine system component 100 simultaneously deposits the material onto the damaged surface 76, while reducing coating layer imperfections on the damaged surface 76. More specifically, a stronger coating on the damaged surface 76 is achieved in an efficient distribution manner.

Although the arrangement and method described above reference a turbine system component, it is to be appreciated that any component being repaired with an electrospark deposition process may benefit from the embodiments described herein.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A component repair arrangement comprising:
a material depositing electrospark rod configured to deposit a material onto a component; and
a first routing hose for flowing a first shielding gas to a location proximate a tip of the material depositing electrospark rod, the first shielding gas removing a plurality of sparks generated proximate the tip.

2. The component repair arrangement of claim 1, further comprising a second routing hose for flowing a second shielding gas proximate a surface of the component to protect the surface from oxidation.

3. The component repair arrangement of claim 1, wherein the component comprises a turbine system component.

4. A method of repairing a component comprising:
depositing a material by electrospark deposition to a damaged surface of the component; and
flowing a first shielding gas proximate the damaged surface during deposition of the material for removing a plurality of sparks from the damaged surface.

5. The method of claim 4, wherein the material is deposited by electrospark deposition in a plurality of passes proximate the damaged surface.

6. The method of claim 4, further comprising flowing a second shielding gas to reduce oxidation proximate the damaged surface of the component, wherein the material comprises a damaged surface material.

7. The method of claim 4, wherein the material comprises a first material and the damaged surface comprises a second, distinct damaged surface material.

8. The method of claim 4, wherein the shielding gas comprises argon.

9. The method of claim 4, further comprising fusion bonding the material to the damaged surface upon depositing the material.

10. The method of claim 4, wherein the component comprises a turbine system component, the turbine system component comprising a rabbet structure disposed within at least one of a compressor section and a turbine section of a turbine system.

11. The method of claim 10, wherein the rabbet structure is disposed proximate at least one of a turbine wheel, a turbine spacer and a turbine shaft.

12. The method of claim 10, wherein the turbine system component comprises an airfoil.

13. A method of repairing a turbine system component comprising:
depositing a material by electrospark deposition in a plurality of passes to a damaged surface of the turbine system component;
flowing a shielding gas at a first velocity proximate the damaged surface during at least one of the plurality of passes for removing a plurality of sparks from the damaged surface; and
flowing the shielding gas at a second velocity proximate the damaged surface during at least one of the plurality of passes, wherein the first velocity is greater than the second velocity.

14. The method of claim 13, wherein flowing the shielding gas at a first velocity proximate the damaged surface during at least one of the plurality of passes comprises flowing the shielding gas during a first pass proximate the damaged surface.

15. The method of claim 13, wherein the material comprises a damaged surface material.

16. The method of claim 13, wherein the material comprises a first material and the damaged surface comprises a second, distinct damaged surface material.

17. The method of claim 13, wherein the shielding gas comprises argon.

18. The method of claim 13, further comprising fusion bonding the material to the damaged surface upon depositing the material.

19. The method of claim 13, wherein the turbine system component comprises a rabbet structure disposed within at least one of a compressor section and a turbine section of a turbine system.

20. The method of claim 13, wherein the turbine system component comprises an airfoil.
